(19) United States
(12) Patent Application Publication
(10) Pub. No.: US 2006/0048554 A1
(43) Pub. Date: Mar. 9, 2006

(54) Rotary locking cylinder for a safety lock

(75) Inventor: Ernst Keller, Richterswil (CH)

Correspondence Address: BROWDY AND NEIMARK, P.L.L.C.;624 NINTH STREET, NW, SUITE 300, WASHINGTON, DC, 20001-5303, US

(73) Assignee: Keso AG, Richterswil (CH)

(21) Appl. No.: 11/220,379

(22) Filed: Sep. 7, 2005

(30) Foreign Application Priority Data
Sep. 7, 2004 (EP) 04 405 554.9

(51) Int. Cl. E05B 27/04; E05B 15/16

(52) U.S. Cl. 70/493; 70/356; 70/417

(57) ABSTRACT

The rotary locking cylinder has a stator with a rotor and with tumblers which are to be arranged in place for the rotary release of the rotor using an associated key. At least one core pin consists of at least one inner part and one outer part. The length of the outer part and the length of the associated housing pin together result in a length which is greater than a length of a hole in which the housing pin is mounted. The rotary locking cylinder also cannot be opened by means of the “bump technique”.

The invention relates to a rotary locking cylinder for a safety lock, comprising a stator and at least one rotor having a key channel, comprising tumblers which are to be arranged in place for the rotary release of the rotor using an associated key and which each have a core pin and a spring-loaded housing pin.

Rotary locking cylinders of this type have been known for a long time. They ensure high security. Like other safety devices, they are subject to manipulations for unauthorized opening. In particular simple and cheap locking cylinders are often unable to withstand such manipulations. One of these opening methods is known as “bump technique”. This opening method is difficult to detect and basically does not damage the rotary locking cylinder.

Used in this method is a blank which has a profiled portion which corresponds to that of the cylinder to be manipulated. Since the profiled portions of the cylinders are different, a corresponding set of blanks is required. The matching blank is selected from this set. The corresponding associated blank is inserted into the key channel and is held under pressure at the key handle with a suitable torque in the desired rotary position of the rotor. A blow is now simultaneously applied to the handle using a bump tool. An impulse is exerted on the respective rotor pins by the blank. According to the percussion principle, the core pins each transmit the impulse to the associated housing pin. The core pins are left behind in the process. Due to the impulse received, the housing pins are briefly moved outward beyond the separating line into the stator against the reactive force of the housing spring. Since the housing springs now no longer lock the rotor, the latter is free and can be rotated and thus the rotary locking cylinder can be opened. The blank can be removed and used for further manipulations.

The object of the invention is to provide a rotary locking cylinder of the abovementioned type which reliably prevents this opening method and which nonetheless can be produced in a functionally reliable and favorable manner.

In a rotary locking cylinder of the generic type, this object is achieved in that at least one core pin consists of at least one inner part and one outer part, the length of the outer part and the length of the associated housing pin together resulting in a length which is greater than a length of a hole in which the housing pin is mounted. In the rotary locking cylinder according to the invention, the housing pins can continue to be moved outward into the stator during a manipulation according to the abovementioned principle. However, the inner part of the core pin moves outward at the same time as the housing pins. On account of said length ratios, this inner part assumes the locking of the rotor. In principle, it is sufficient if only one tumbler of this kind has a core with an outer part and an inner part. However, greater security is achieved if a plurality of tumblers of this kind are formed at the same time. The costs for the production of the rotary locking cylinder are not substantially higher than in the case of a rotary locking cylinder which permits said manipulations.

According to a development of the invention, the inner part is the same length in all the two-part core pins. The inner part is preferably made of a hard material, for example hardened steel. Since all these parts can be of identical design, their production and the corresponding assembly is simple or cost-effective. The inner part may be made of a comparatively soft material, for example brass or nickel silver, since this part is subjected to less stress than the inner part, which is in engagement with the key. The effective length of the core pins is therefore determined by the inner parts. These inner parts are accordingly of different length.

The outer part of the core pin and also the inner part are preferably cylindrical and can be completely separated from one another radially.

According to a development of the invention, the outer part of the core pin is undercut. This gives even greater security and also prevents other opening methods. If such an undercut part is moved outward into the stator during said manipulation, it can no longer, as a rule, with canted rotor, move back into the rotor and remains in the locking position. This is even intensified if, according to a development of the invention, the hole in the stator is also undercut.

The housing pins are preferably in each case mounted in slides. The housing pins and the associated springs can then be put into the slides outside the stator. The core pins are inserted into the stepped holes of the rotor. The fitting of the core pins is simplified when, according to a development of the invention, the two parts of the core pin have a recess and a corresponding extension, respectively, at the surfaces in contact with one another.

According to a development of the invention, provision is made for the housing pin and the outer part of the core pin to be magnetically connected to one another, at least at one tumbler. This is done in particular by magnetic pins which are firmly inserted into said parts. The magnetic connection ensures that the housing pin and the outer part are reliably connected to one another and are simultaneously moved outward during said manipulation. The housing pin and the inner part thus form a type of stack which is released from the inner part and shifts outward during said manipulation.

The bump technique can be prevented even more effectively if the two parts of the core pin have a recess and a corresponding extension, respectively, at the surfaces in contact with one another. After separation of the two parts, it is then scarcely possible to arrange these two parts in place with canted rotor.

Exemplary embodiments of the invention are explained in more detail below with reference to the drawing, in which:

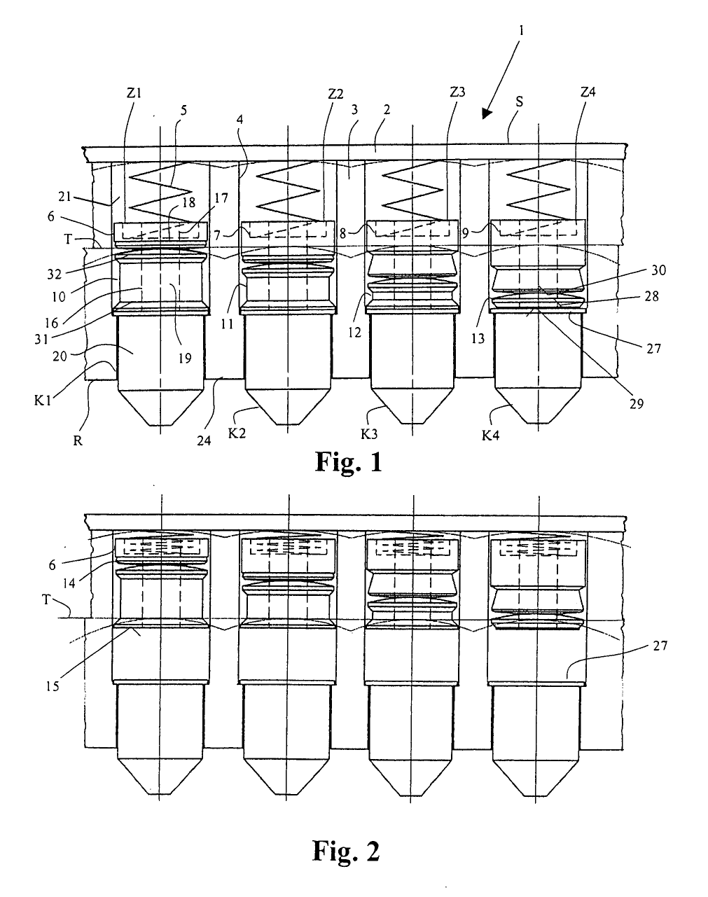

FIG. 1 shows a partial view through a rotary locking cylinder according to the invention in the rest position,

FIG. 2 shows a view according to FIG. 1 but during a manipulation phase,

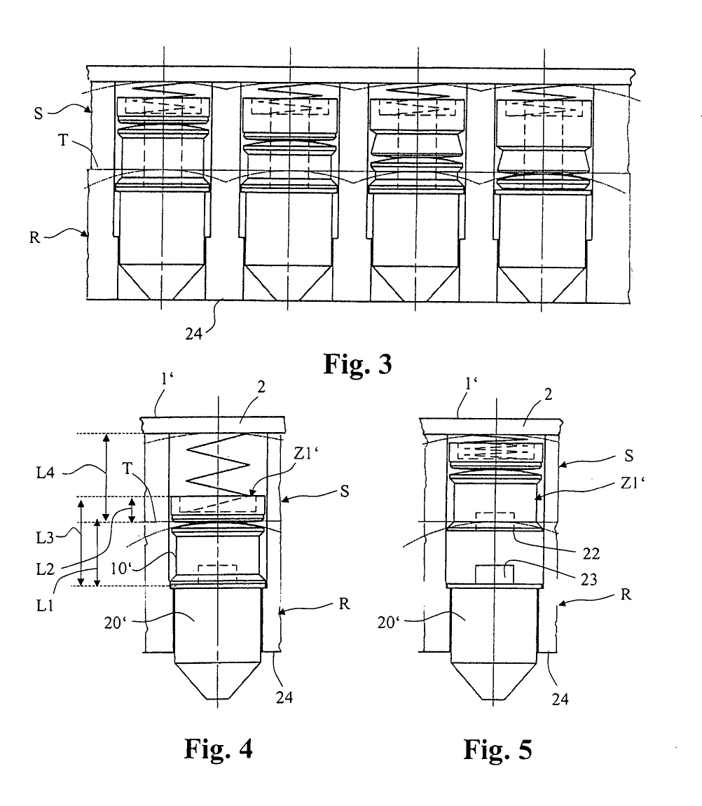

FIG. 3 shows a view according to FIG. 1, all the parts of the tumblers being positioned radially on the outside,

FIG. 4 shows a variant of a tumbler according to the invention,

FIG. 5 shows the tumbler according to FIG. 4, but with the two parts of the core pin being separated,

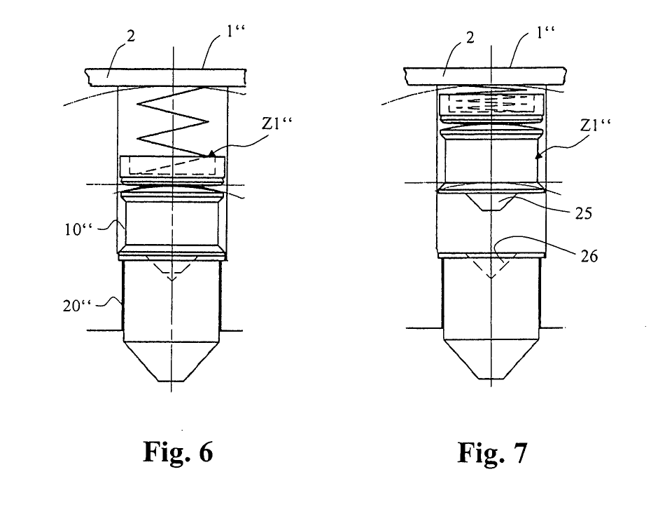

FIG. 6 shows a variant of a tumbler according to the invention,

FIG. 7 shows the tumbler according to FIG. 6, but with the two parts of the core pin being separated.

The rotary locking cylinder 1 shown in FIG. 1 is a simple rotary locking cylinder or a double rotary locking cylinder and has a stator S and a rotor R. As a rule, the stator S has three slides 3, of which only one is shown here. These slides 3 are inserted into a stator housing (not shown in any more detail here) and have a plurality of respective holes 4 which each accommodate a helical spring 5 and a housing pin 6 to 9. In the basic position shown in FIG. 1, the housing pins 7, 8 and 9 cross a separating line T between the stator S and the rotor R and thereby lock the rotor R. In addition, the stator S has a sleeve 2 which closes the holes 21 of the slides 3 on the outside and on which the springs 5 are supported. However, the stator S may also be constructed in a conventional manner without slides 3 and sleeve 2.

The rotor R forms a key channel 24, into which the shank of the associated key can be pushed for arranging the tumblers Z1 to Z4 in place. The key (not shown here) may be of any desired design as such, i.e. it may be, in particular, a reversible key with holes or a “serrated key”. In FIG. 1, the key channel 24 is open on the left.

The rotor R has radially stepped holes 21 in which core pins K1 to K4 are mounted. As can be seen, these core pins K1 to K4 project into the key channel 24 in the rest position. The core pins K1 to K4 are held by the springs 5 in the rest position shown. These positions are defined by the shoulders of the stepped holes 21.

The core pins K1 to K4 each consist of an inner part 20 and one of the outer parts 10 to 13. As can be seen, the inner parts 20 are all the same length and are of identical design. At a rear end, they have a respective collar 27 which is directed radially outward and bears against said shoulder in the stepped hole. The inner parts 20 are preferably made of a hard material, in particular hardened steel. The rear side of the core pins 20 is formed by a respective flat surface 28. One of the outer parts 10 to 13 bears in each case with a flat inner surface 15 (FIG. 2) against these flat and closed surfaces 28. As can be seen, the outer parts 10 to 13 are of different length. The effective length of the core pins K1 to K4 is therefore determined by the different lengths of the outer parts 10 to 13. The outer parts 10 to 13 each have an inner surface 29 and an outer surface 30. The inner surfaces 29 are preferably likewise flat and bear flat against one of the surfaces 27 of the inner part 20. On the other hand, the outer surfaces 30 are crowned and bear against a respective inner surface 15 of one of the housing pins 6 to 9. The inner parts 20 and the outer parts 10 to 13 therefore bear loosely and in a planar manner against one another. The parts 20 and 10 to 13 can be completely separated from one another radially.

According to FIG. 1, the inner parts 20 are in each case located entirely in the rotor R and therefore have no locking function in the rest position.

If the core pins K1 to K4 are acted upon by a blank as mentioned above, a radial impulse is simultaneously exerted on said core pins K1 to K4. This impulse is transmitted in each case from the inner part 20 to the corresponding outer part 10 to 13 and finally to the corresponding housing pin 6 to 9. According to the percussion principle, the inner parts 20 are left essentially in the position shown in FIG. 1. The outer parts 10 to 13 and the housing pins 6 to 9, however, are moved outward against the reactive force of the springs 5 into the position shown in FIG. 2. As shown in FIG. 2, all the outer parts 10 to 13 now lock the rotor R. The parts 10 to 13 therefore cross the separating line T. The rotor R is thus locked and cannot be rotated.

The state shown in FIG. 2 will occur only very briefly, since the springs 5 immediately move the housing pins 6 to 9 and the outer pins 10 to 13 back into the position shown in FIG. 1. The inner surfaces 15 of the outer parts 10 to 13 and the flat surfaces 28 of the inner parts 20 strike one another again in the process.

The outer parts 10 to 13 and the housing pins 6 to 9 are in each case provided with an inner radial hole 16 or 17, respectively, into which a magnet pin 18 or 19, respectively, is firmly inserted. The magnets 18 and 19 are in each case permanent magnets and are fixed in the corresponding hole 16 or 17, respectively. These magnet pins 18 and 19 connect the outer parts 10 to 13 in each case to one of the housing pins 6 to 9. However, the magnetic force only acts radially in each case, so that the inner parts 10 to 13 can readily be separated from the housing pins 6 to 9 during the rotation of the rotor R. However, the magnetic connection has the advantage that the inner parts 10 to 13 and the housing pins 6 to 9, during the exertion of said radial impulse, can be moved with one another in an even more reliable manner and therefore cannot be separated from one another with said percussion principle.

The outer parts 10 to 12 are each undercut. As a result, an inner margin 31 and an outer margin 32, which each project radially, is formed in each case. If the outer parts 10 to 12 according to FIG. 2 are located in the outer position, they are each moved inward again by the springs 5 as mentioned above. If a torque is exerted on the rotor R as mentioned above, the holes 21 in the rotor R and the holes 4 in the stator S are offset slightly from one another in the circumferential direction. Due to this offset, the inner margin 32 can no longer cross the separating line T. This also applies in the opposite direction due to the margin 31. As a result, the outer parts 10 to 12 are blocked or jammed and can essentially no longer be moved. As a result, other manipulation attempts also become ineffective. The effect can even be intensified by the holes 4 likewise being undercut. To this end, reference is made to EP 0 937 843 A, which shows slides with undercut holes. In addition, the housing pins may also be undercut, as is the case according to FIG. 1 with the housing pins 8 and 9.

The lengths L1, L2, L3 and L4 shown in FIG. 4 or their interrelationships are important. The length L1 is the length of the outer parts 10 to 13. The length L2 is the length of the housing pins 6 to 9. As can be seen, these lengths are different in each case. The length L3 is the sum of the lengths L1 and L2. This length L3 is greater than the length L4, which is the length of the holes 21. Therefore L1+L2>L4. This relationship ensures that the outer parts 10 to 13 always lock in the position according to FIG. 2. This also applies if, according to FIG. 3, the inner parts 20 are in each case also shifted outward and thus do not project into the key channel 24.

FIGS. 4 and 5 show a variant of a tumbler Z1′. In this tumbler Z1′, the outer part 10′ has a cylindrical recess 22 on the inside, and the inner part 20′ has a corresponding cylindrical stem 23. In the neutral position according to FIG. 5, the stem 23 engages in the recess 22. As a result, the two parts 10′ and 20′ are centered relative to one another. Moreover, this arrangement simplifies assembly.

In the case of the tumbler Z1″ shown in FIGS. 6 and 7, the engagement is effected by a cone 25 which is centered on the corresponding recess 26 in the rest position.

In the case of the tumblers Z1′ and Z1″, the parts 10′ and 20′ and respectively 10″ and 20″ also bear in each case loosely against one another and can therefore be completely separated from one another according to said percussion principle.

In addition, the recesses 22 and 26 and also the cylindrical stem 23 and the cone 25 are effective during application of the abovementioned bump technique and can prevent the latter. If the two parts 10′ and 20′ and respectively 10″ and 20″ of the core pin are separated on account of said bump technique, as is shown in FIGS. 5 and 7, the rotor R is locked and the lock cannot be opened. Nonetheless, in order to be able to open the lock, it may now be attempted to displace the outer part 10′ or 20′, respectively, inward by moving the rotor R, which is assisted by the housing spring 5. If this succeeds and this outer part crosses the separating line 10′ or 10″, respectively, the rotor R is released and the lock can be opened. During this displacement of the outer part 10′ or 10″, respectively, the rotor R has to be canted. As a result of this canting, the outer part 10′ or 10″, respectively, is correspondingly tilted in the hole of the rotor R. Without this tilting, the other tumblers would immediately lock the rotor R again. It has now been found that such a tilted outer part 10′ or 10″, respectively, cannot be brought into an unlocked position, since the stem 23 or the cone 25, respectively, and the recess 22 or 26, respectively, cannot be fitted. This is especially effective in the embodiment according to FIGS. 4 and 5, since the stem 23 can only be inserted into the recess 22 when the outer part and the inner part are exactly aligned with one another. The outer part 10′ or 10″ therefore cannot be moved inward to a sufficient extent and always remains in the locking position. The rotor R therefore cannot be rotated and the lock accordingly cannot be opened. This therefore results not only in the advantage of the simpler assembly already mentioned in the application documents but also in greater security against said bump technique.

List of Designations

1 Locking cylinder
2 Sleeve
3 Slide
4 Hole
5 Spring
6 Housing pin
7 Housing pin
8 Housing pin
9 Housing pin
10 Outer part
11 Outer part
12 Outer part
13 Outer part
14 Outer surface
15 Inner surface
16 Hole
17 Hole
18 Magnet
19 Magnet
20 Inner part
21 Hole
22 Recess
23 Stem
24 Key channel
25 Cone
26 Recess
27 Collar
28 Surface
29 Surface
30 Surface
31 Margin
32 Margin
K Core pins
L1-L4 Length
R Rotor
S Stator
T Separating line
Z1-Z4 Tumblers

1. A rotary locking cylinder for a safety lock, comprising a stator and at least one rotor having a key channel, comprising tumblers which are to be arranged in place for the rotary release of the rotor using an associated key and which each have a core pin a spring-loaded housing pin, wherein at least one core pin consist of at least one inner part and one outer part, the length of the outer part and the length of the associated housing pin together resulting in a length which is greater than a length of a hole in which the housing pin is mounted.

2. The rotary locking cylinder as claimed in claim 1, wherein the inner part is the same length in all the two-part core pins.

3. The rotary locking cylinder as claimed in claim, wherein the outer part is completely separable radially from the respective inner part.

4. The rotary locking cylinder as claimed in claim 1, wherein the inner part of the core pin is made of a hard material, optionally hardened steel.

5. The rotary locking cylinder as claimed in claim 1, wherein the outer part of the core pin is made of a comparatively soft material, optionally brass or nickel silver.

6. The rotary locking cylinder as claimed in claim 1, wherein the housing pins are each mounted in a slide.

7. The rotary locking cylinder as claimed in claim 1, wherein the outer part is undercut.

8. The rotary locking cylinder as claimed in claim 1, wherein at least one hole for a housing pin is undercut.

9. The rotary locking cylinder as claimed in claim 1, wherein the outer part and the housing pin are magnetically connected to one another.

10. The rotary locking cylinder as claimed in claim 9, wherein the outer part and the housing pin each have a part which is a magnet, optionally a permanent magnet.

11. A rotary locking cylinder for a safety lock, comprising a stator and at least one rotor having a key channel, comprising tumblers which are to be arranged in place for the rotary release of the rotor using an associated key and which each have a core pin and a spring-loaded housing pin, at least one core pin consists of at least one inner part, as viewed in the radial direction, and one outer part, the length of the outer part and the length of the associated housing pin together resulting in a length which is greater than a length of a hold in which the housing pin is mounted, the outer part moving outward with the housing pin in the event of a hard blow on the inner part, whereas the inner part remains essentially in the initial position, the two parts of the core pin having a recess and a corresponding extension, respectively, at the surfaces in contact with on another.

12. The rotary locking cylinder as claimed in claim 11, wherein the recess is cylindrical and the extension is a cylindrical stem.

13. The rotary locking cylinder as claimed in claim 11, wherein the recess is conical and the extension is a cone.

14. The rotary locking cylinder as claimed in claim 2, wherein the outer part is completely separable radially from the respective inner part.

15. The rotary locking cylinder as claimed in claim 14, wherein the inner part of the core pin is made of a hard material, optionally hardened steel.

16. The rotary locking cylinder as claimed in claim 15, wherein the outer part of the core pin is made of a comparatively soft material, optionally brass or nickel silver.

17. The rotary locking cylinder as claimed in claim 16, wherein the housing pins are each mounted in a slide.

18. The rotary locking cylinder as claimed in claim 17, wherein the outer part is undercut.

19. The rotary locking cylinder as claimed in claim 18, wherein at least one hole for a housing pin is undercut.

20. The rotary locking cylinder as claimed in claim 19, wherein the outer part and the housing pin are magnetically connected to one another.
